(19) United States
(12) Patent Application Publication
(10) Pub. No.: US 2025/0046913 A1
(43) Pub. Date: Feb. 6, 2025

(54) Battery Pack Assembly For Providing Structure and Support, Coolant Circulation and Electrical Connections To A Plurality of Battery Cells

(71) Applicant: Celanese Polymers Holding, Inc., Wilmington, DE (US)

(72) Inventors: Fabrice S. J-M Giaume, Peillonnex (FR); Bryan Martin Morris, Coppet (CH)

(21) Appl. No.: 18/789,767

(22) Filed: Jul. 31, 2024

Related U.S. Application Data
(60) Provisional application No. 63/517,800, filed on Aug. 4, 2023.

(51) Int. Cl. H01M 10/6568; H01M 10/613; H01M 10/625; H01M 50/213; H01M 50/227; H01M 50/505; H01M 50/516

(52) U.S. Cl. CPC H01M 10/6568; H01M 10/613; H01M 10/625; H01M 50/213; H01M 50/227; H01M 50/505; H01M 50/516

(57) ABSTRACT

A battery pack structural and electrical assembly for circulating a coolant fluid is disclosed. The battery pack assembly includes a top cooling fluid distribution manifold attached to the top of a plurality of battery cells and a bottom cooling fluid distribution manifold that is attached to the bottom of the battery cells. A coolant fluid is circulated through the manifolds for cooling the battery cells directly. Electrical connections to the battery cells can be integrated into the manifolds for also efficiently providing electrical connections to the batteries. In addition, the battery assembly provides significant impact resistance for protecting the battery cells.

### RELATED APPLICATIONS

The present application is based upon and claims priority to U.S. Provisional Application Ser. No. 63/517,800 having a filing date of Aug. 4, 2023, which is incorporated herein by reference.

### BACKGROUND

Conventional battery packs for electric vehicles typically comprise battery cells mounted within a metallic housing of steel and/or aluminum having reinforcing elements to increase stiffness and integrity of the pack in the event of a crash. Since the batteries generate heat during use, battery cells are placed on a separate cooling plate mounted within the metallic housing. In order to ensure sufficient heat flow from the battery cells to the cooling element, it is known to provide a thermal interface material inserted between battery cells and the cooling element to improve contact and heat flow through conduction. Since battery cells need to be electrically interconnected and connected to the external cable connected to the battery pack, it is typical to provide cells with a cell-to-cell bus bar for electrical interconnection of the cells.

In the past, various different systems were used in order to house, cool and connect a plurality of battery cells within an electric vehicle. For instance, conventional battery packs typically included a metallic housing as described above that was separate from a cooling fluid system. In addition, a separate electrical system was then used to connect the batteries together and to connect the batteries to one or more external cables. Thus, conventional systems for supporting batteries in electric vehicles were complicated and required multiple assembly components with increased assembly complexity and associated manufacturing costs.

In view of the above, a need exists for an improved structure and system capable of protecting, cooling and forming an electrical connection with a plurality of battery cells.

### SUMMARY

In general, the present disclosure is directed to a battery pack structural and electrical assembly for circulating a coolant fluid. The coolant fluid can comprise, for instance, a dielectric oil, a fluorinated oil, a mineral oil, or a glycol. The battery pack assembly is designed, in one aspect, such that the coolant fluid is in direct contact with battery cells mounted within the structure. In this regard, the battery pack assembly includes a manifold that can be molded from a thermoplastic polymer that is directly attached to the battery cells and facilitates electrical connections to each of the cells. Multiple battery cells, for instance, can be attached to the same manifold and their electrical connectors can be connected either in parallel or in series. The battery pack assembly, for instance, can serve multiple functions including providing structure and protection to a plurality of battery cells, facilitating electrical connections, and circulating a coolant fluid in an efficient manner.

In one aspect, for instance, the present disclosure is directed to a battery pack structural and electrical assembly for circulating a coolant fluid that comprises a top cooling fluid distribution manifold opposite a bottom cooling fluid distribution manifold. The top cooling fluid distribution manifold comprises a top battery plate spaced from a top cover plate that defines a space therebetween for circulating a coolant fluid. The top cooling fluid distribution manifold further comprises a first conductive battery member and a second conductive battery member. The first and second conductive battery members are attached to the top cover plate. The top cooling fluid distribution manifold is configured to attach and seal against a plurality of battery cells for circulating a coolant fluid that contacts the battery cells and the first and second conductive battery members. The first conductive battery member can be positioned so as to contact a positive terminal on each battery cell attached to the top cooling fluid distribution manifold and the second conductive battery member can be positioned so as to contact a negative terminal on each battery cell attached to the top cooling fluid distribution manifold.

The bottom cooling fluid distribution manifold comprises a bottom plate spaced from a bottom cover plate and defines a space therebetween for also receiving and circulating a coolant fluid. The bottom cooling fluid distribution manifold is configured to attach and seal against the plurality of battery cells on a side opposite the top cooling fluid distribution manifold for further circulating a coolant fluid that contacts the battery cells.

The battery pack assembly includes at least one fluid passageway that provides fluid communication between the top cooling fluid distribution manifold and the bottom cooling fluid distribution manifold. For instance, the battery pack assembly can include a coolant fluid inlet and a coolant fluid outlet that are in fluid communication with the top cooling fluid distribution manifold and the bottom cooling fluid distribution manifold for flowing a coolant through each manifold. In one aspect, one of the coolant fluid inlet or coolant fluid outlet is connected to the top cooling fluid distribution manifold and the other coolant fluid inlet or coolant fluid outlet is connected to the bottom cooling fluid distribution manifold. The coolant fluid inlet can be positioned adjacent to the coolant fluid outlet.

The bottom cooling fluid distribution manifold can define a plurality of battery cell vents comprising openings in the bottom cover plate. Each opening can be positioned to correspond to a battery cell attached to the bottom cooling fluid distribution manifold. For instance, each battery cell vent can be surrounded by a vent weld ring that is configured to be welded to a corresponding battery cell for preventing a coolant fluid circulating through the bottom cooling fluid distribution manifold from entering the battery cell vents. The bottom plate of the bottom cooling fluid distribution manifold can include a plurality of perimeter weld rings. Each perimeter weld ring can surround and be spaced from a corresponding vent weld ring. Each perimeter weld ring can be configured to attach to a corresponding battery cell.

The top cooling fluid distribution manifold can define a plurality of weld access openings. The weld access openings are positioned over the first conductive battery member and over the second conductive battery member. The weld access openings are configured to provide access to the first conductive battery member for welding the first conductive battery member to corresponding positive terminals on battery cells attached to the top cooling fluid distribution manifold. The weld access openings are also configured to provide access to the second conductive battery member for welding the second conductive battery member to corresponding negative terminals on battery cells attached to the top cooling fluid distribution manifold. In one aspect, the top cooling fluid distribution manifold can include a positive terminal in electrical communication with the first conductive battery member and a negative terminal in communication with the second conductive battery member.

The top battery plate of the top cooling fluid distribution manifold can define a plurality of battery cell openings for mating with a corresponding plurality of battery cells. Each battery cell opening can be surrounded by a top perimeter weld ring for welding to a corresponding battery cell. For example, in one embodiment, the top cooling fluid distribution manifold can be welded to battery cells on one end while the bottom cooling fluid distribution manifold can be welded to the battery cells on an opposite end.

In one aspect, the top battery plate and the top cover plate of the top cooling fluid distribution manifold can be comprised of a polymer. Similarly, the bottom plate and the bottom cover plate of the bottom cooling fluid distribution manifold can also be formed from a polymer. In one aspect, the polymer can be a thermoplastic polymer that is injection molded to form the different parts. Reinforcing fibers can be combined with the thermoplastic resin for increasing the strength of the battery pack assembly. The polymer can comprise a polyamide, a polyolefin, a polyester, a copolyether ester, a polyphenylene sulfide, a polyoxymethylene, or a liquid crystal polymer.

In another aspect, the present disclosure is also directed to a battery pack that includes a battery pack structural and electrical assembly as described above in combination with a plurality of battery cells. The battery pack can include, for instance, at least 8 battery cells, such as at least 10 battery cells, such as at least 12 battery cells, such as at least 14 battery cells, and generally less than about 100 battery cells, such as less than about 50 battery cells.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a battery pack assembly made in accordance with the present disclosure;

FIG. 2 is a perspective view of the battery pack assembly illustrated in FIG. 1;

FIG. 3 is one embodiment of a battery cell that can be incorporated into the battery pack assembly of the present disclosure;

FIG. 4 is a perspective view of the opposite side of the battery cell illustrated in FIG. 3;

FIG. 5 is a partial assembly view of a battery pack assembly made in accordance with the present disclosure;

FIG. 6 is a perspective view of a subassembly of a battery pack assembly in accordance with the present disclosure;

FIG. 7 is a perspective view of a bottom cover plate of a bottom cooling fluid distribution manifold of a battery pack assembly made in accordance with the present disclosure;

FIG. 8 is a perspective view illustrating a bottom cooling fluid distribution manifold of a battery pack assembly in accordance with the present disclosure;

FIG. 9 is a perspective view of one embodiment of a bottom cooling fluid distribution manifold 26 constructed in accordance with the present disclosure;

FIG. 10 is a perspective view of a plurality of battery cells mounted to a bottom cooling fluid distribution manifold of a battery pack assembly of the present disclosure;

FIG. 11 is a perspective view of a partially constructed battery pack assembly in accordance with the present disclosure;

FIG. 12 is a perspective view of a top cover plate of a top cooling fluid distribution manifold of a battery pack assembly made in accordance with the present disclosure;

FIG. 13 is a perspective view of a top cover plate of a top cooling fluid distribution manifold of a battery pack assembly made in accordance with the present disclosure;

FIG. 14 is a perspective view of a top cooling fluid distribution manifold for a battery pack assembly in accordance with the present disclosure; and

FIG. 15 is a perspective view of a battery pack assembly in accordance with the present disclosure in which a top cover plate of a top cooling fluid distribution manifold has been removed in order to illustrate conductive battery members in contact with battery cells in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a battery pack assembly that is capable of performing multiple functions. The battery pack assembly, for instance, can be made from lightweight polymers that provide a plurality of battery cells with structural support and impact strength resistance. In addition, the battery pack assembly includes a plurality of manifolds that not only hold the battery cells in position but also permit the circulation of a coolant fluid for cooling the battery cells during use. The coolant fluid can comprise a dielectric oil, a fluorinated oil, a mineral oil, or a glycol. Conductive members can also be integrated with one of the manifolds for providing the batteries with electrical connections. The conductive members can be made from a conductive metal. Thus, the battery pack assembly of the present disclosure is capable of combining a cooling system with a structural member and electrical connections in an efficient and seamless manner.

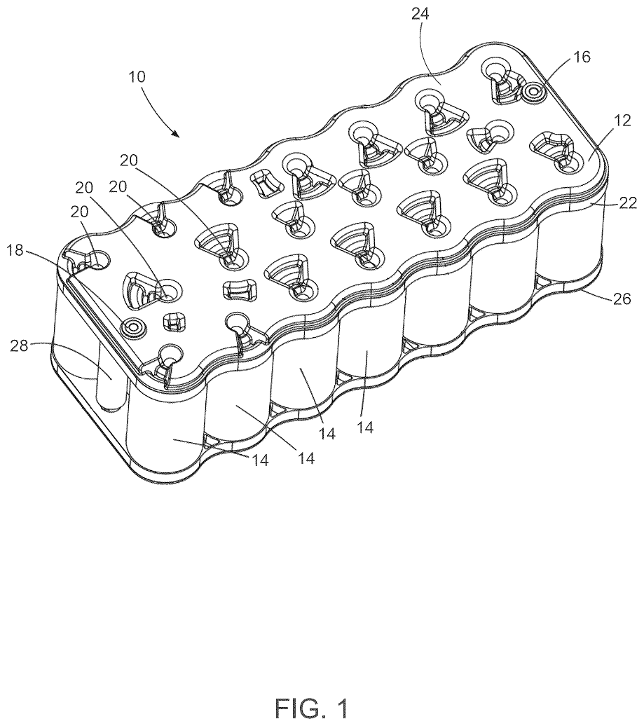

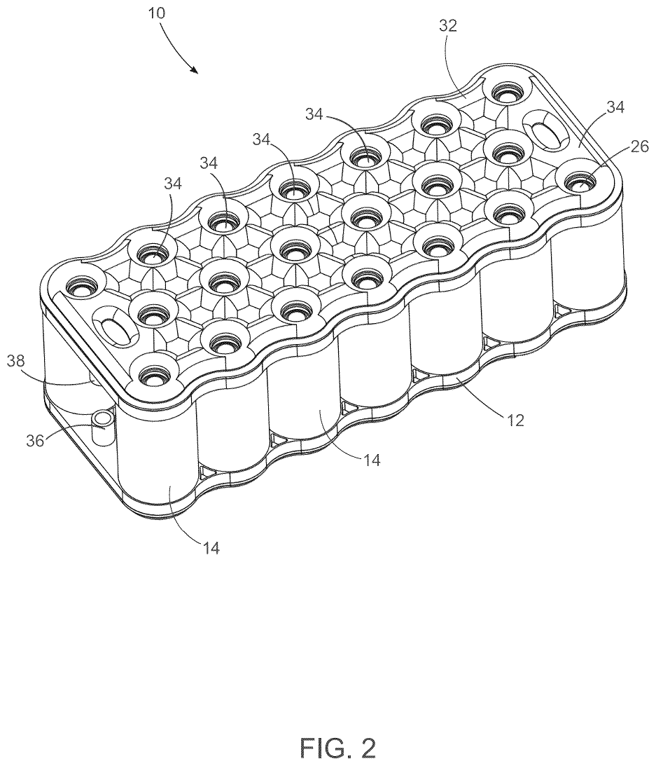

Referring to FIGS. 1 and 2, one embodiment of a battery pack assembly 10 made in accordance with the present disclosure is shown. FIG. 1 illustrates the top of the battery pack assembly 10 while FIG. 2 illustrates the bottom. Referring to FIG. 1, the top of the battery pack assembly 10 includes a top cooling fluid distribution manifold 12 that includes a hollow interior for circulating a coolant fluid that is designed to directly contact a plurality of battery cells 14. In addition, the top cooling fluid distribution manifold 12 contains conductive members that make an electrical connection with the battery cells 14. For example, as shown in FIG. 1, the top cooling fluid distribution manifold 12 can include a positive terminal 16 and a negative terminal 18. The positive terminal 16 can be in electrical communication with the positive terminals on all of the battery cells 14 while the negative terminal 18 can be in electrical communication with all of the negative terminals on the battery cells 14.

In one aspect, the top cooling fluid distribution manifold 12 can optionally include a plurality of weld access openings 20. As will be explained in detail below, the weld access openings 20 are for connecting the conductive members to the battery cells 14.

The top cooling fluid distribution manifold 12, in one aspect, is comprised of a top battery plate 22 spaced from a top cover plate 24. A space is defined between the top battery plate 22 and the top cover plate 24 for circulating a coolant fluid. The top battery plate 22 is attached and sealed against the battery cells 14. The top cover plate 24, on the other hand, can be preassembled with conductive members that are then welded to the positive and negative terminals on the battery cells 14.

Spaced from the top cooling fluid distribution manifold 12 is a bottom cooling fluid distribution manifold 26. The bottom cooling fluid distribution manifold 26 can also be attached to the battery cells 14 and can include a space for circulating a coolant fluid. As shown in FIG. 1, the battery pack assembly 10 can include a cooling fluid channel 28 for placing the top cooling fluid distribution manifold 12 in fluid communication with the bottom cooling fluid distribution manifold 26.

Referring to FIG. 2, the opposite side of the battery pack assembly 10 from FIG. 1 is illustrated. The bottom cooling fluid distribution manifold 26 is shown in greater detail. The bottom cooling fluid distribution manifold 26 includes a bottom battery plate 30 spaced from a bottom cover plate 32. Both the bottom battery plate 30 and the bottom cover plate 32 can be attached to the battery cells 14 for defining a sealed coolant fluid space therebetween.

In one embodiment, the bottom cooling fluid distribution manifold 26 can include battery cell vents 34 for further cooling the battery cells 14. In one aspect, each battery cell 14 can be in communication with a corresponding battery cell vent 34.

As shown in FIG. 2, the top cooling fluid distribution manifold 12 can include a cooling fluid inlet 36 while the bottom cooling fluid distribution manifold 26 can include a cooling fluid outlet 38. In this manner, coolant fluid can be introduced into the top cooling fluid distribution manifold 12 and directed into the cooling fluid channel 28 for entering the bottom cooling fluid distribution manifold 26. From the bottom cooling fluid distribution manifold 26, the coolant fluid can exit and optionally be cooled prior to being recirculated through the battery pack assembly 10. In one aspect, a pump can be used to pump the coolant fluid between the top cooling fluid distribution manifold 12 and the bottom cooling fluid distribution manifold 26. Further, it should be understood that the fluid inlet 36 and the fluid outlet 38 can be reversed depending upon the desired fluid path chosen for a particular pack of battery cells 14.

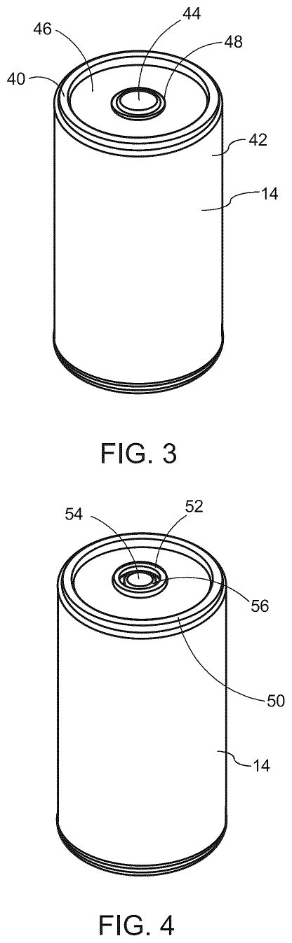

Referring to FIGS. 3 and 4, an individual battery cell 14 is illustrated. In one aspect, each individual battery cell 14 can include a plurality of weld rings or polymeric rings that are attached to each battery cell prior to the assembly of the battery pack. In one embodiment, the rings can serve as thermoplastic welding points for welding the battery cells 14 to the manifolds 12 and 26.

FIG. 3 illustrates a top of the battery cell 14. As shown, the top can include a top perimeter weld ring 40 that is attached to the battery cell casing 42. As shown in FIG. 3, the top of the battery cell 14 can include a positive pole 44 that is surrounded by a negative pole 46. An insulator 48 can separate the positive pole 44 from the negative pole 46. The top perimeter weld ring 40 is for attaching the battery cell 14 to the top cooling fluid distribution manifold 12.

FIG. 4 illustrates the bottom of the battery cell 14. As shown, the bottom includes a bottom perimeter weld ring 50 spaced from a vent weld ring 52. The vent weld ring 52 surrounds a battery vent 54. The battery vent 54 is surrounded by a battery venting seal 56. The bottom perimeter weld ring 50 and the vent weld ring 52 are for attaching the bottom of the battery cell 14 to the bottom cooling fluid distribution manifold 26.

In one aspect, the top perimeter weld ring 40, the bottom perimeter weld ring 50 and the vent weld ring 52 can be made from a thermoplastic polymer that is amenable to a welding process, such as a laser welding process and/or an ultrasonic welding process. In still another alternative embodiment, the weld rings can be thermally bonded to the manifolds 12 and 26.

The weld rings 40, 50 and 52 can be attached directly to the battery cell 14. Alternatively, the weld rings 40, 50 and 52 can be first attached to a battery cap that is then attached to the battery casing 42.

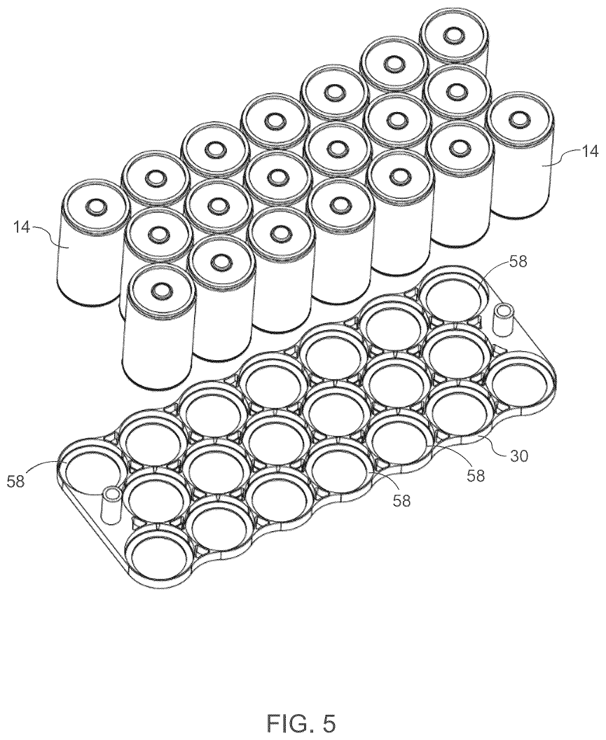

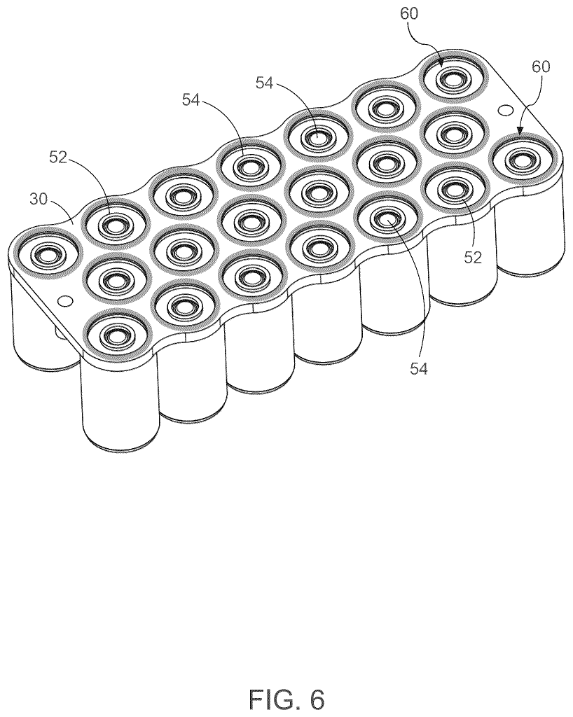

Referring now to FIGS. 5-9, the construction of the bottom cooling fluid distribution manifold 26 is shown in greater detail. Referring to FIG. 5, the bottom battery plate 30 is shown in relation to a plurality of battery cells 14. The bottom battery plate 30 includes a plurality of circumferential welding bands 58. The circumferential welding bands can be welded to the bottom perimeter weld ring 50 on the bottom of each battery cell 14 as shown in FIG. 4. FIG. 6 shows the bottom battery plate 30 welded to the plurality of battery cells 14. As shown, the bottom battery plate 30 includes battery cell openings that expose the bottom of each battery cell 14. As illustrated, once the bottom battery plate 30 is welded to the battery cells 14, the vent weld rings 52 and the battery vents 54 remain exposed.

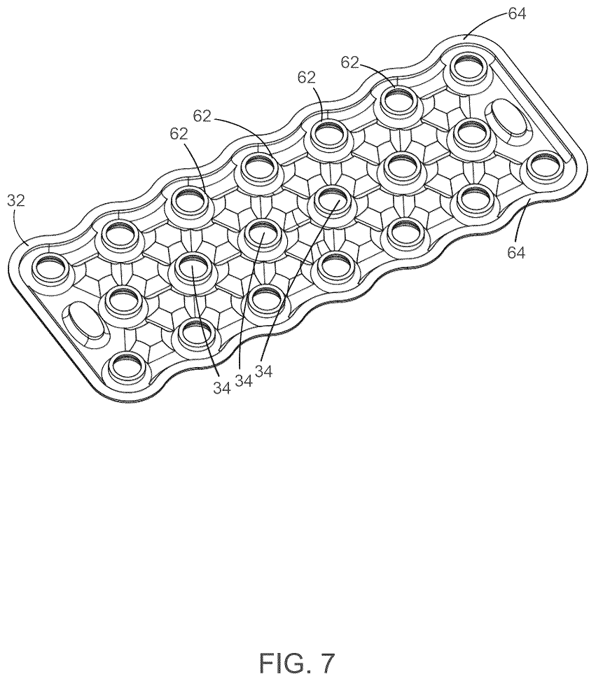

Referring to FIG. 7, the bottom cover plate 32 is shown in greater detail. As illustrated, the bottom cover plate 32 defines the battery cell vents 34. Surrounding each cell vent 34 is a vent welding ring 62. Each vent welding ring 62 is for welding to the vent weld ring 52 on the bottom of each battery cell 14 as shown in FIG. 4. The bottom cover plate 32 further includes a perimeter weld 64 for welding or otherwise forming a seal with the bottom battery plate 30.

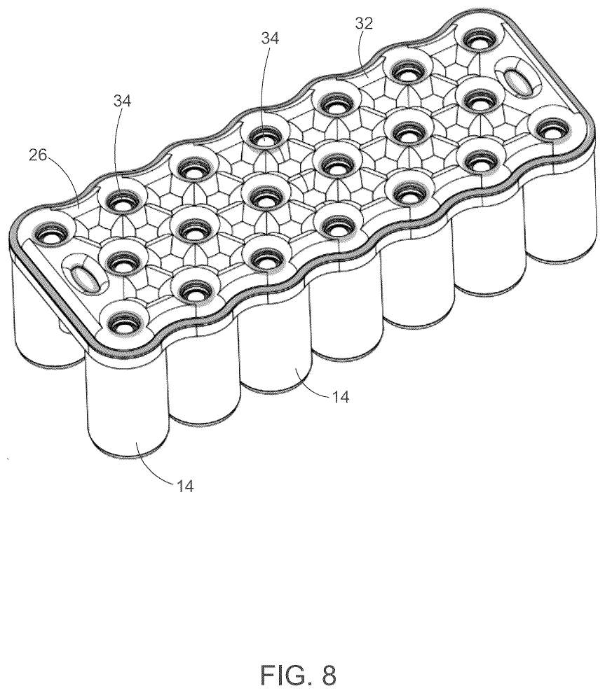

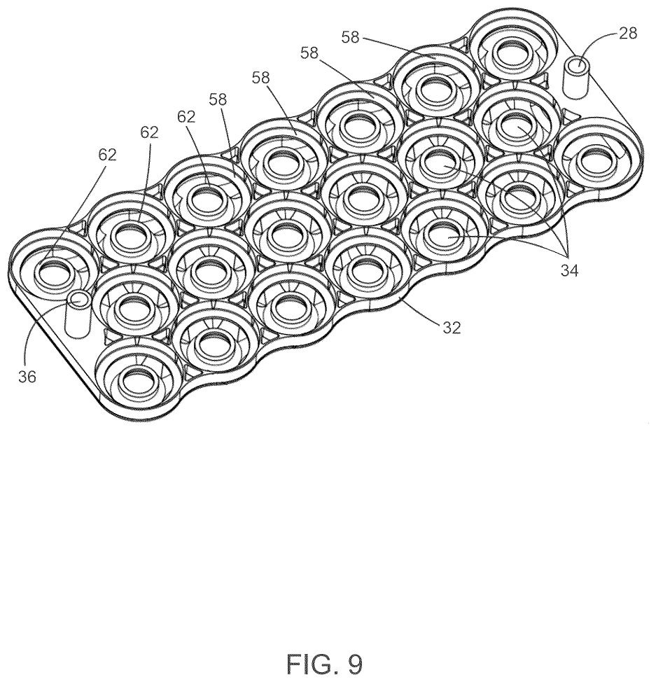

Referring to FIGS. 8 and 9, the bottom cooling distribution manifold is shown in an assembled condition. In FIG. 8, the bottom cooling distribution manifold 26 is shown attached to the banks of battery cells 14. Referring to FIG. 9, once the battery bottom plate 30 is attached to the bottom cover plate 32, a space is defined therebetween. The space is for receiving a coolant fluid that is configured, in one embodiment, to directly contact the battery cells 14. In particular, the coolant fluid is capable of contacting the bottom of each battery cell while being sealed from the battery cell vents 34 by the vent welding rings 62.

As shown in FIG. 8, the bottom cooling fluid distribution manifold 26 is constructed for circulating a coolant fluid for contacting the bottom of each battery cell 14 while still forming battery cell vents 34 that allow the vent 54 on each battery cell 14 to vent thermal energy.

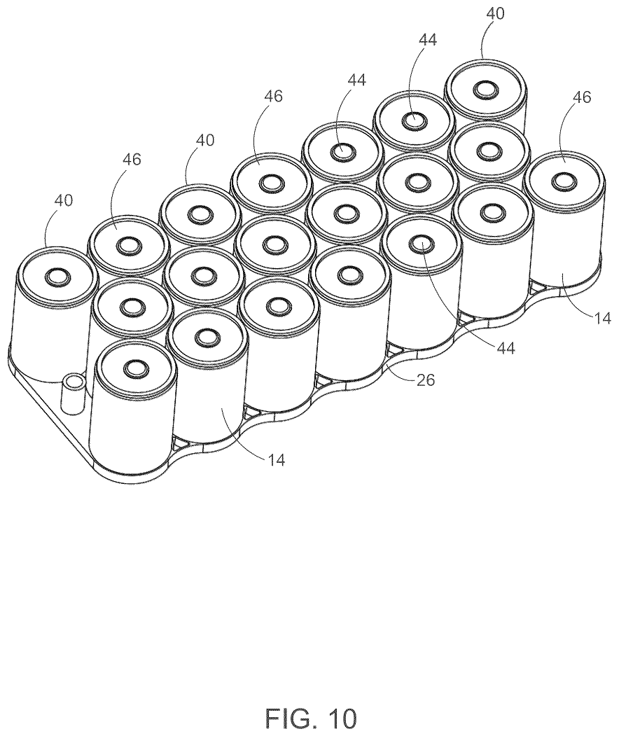

Referring now to FIGS. 10-15, the construction of the top cooling fluid distribution manifold 12 is shown in greater detail. Referring to FIG. 10, the battery cells 14 are shown attached to the bottom cooling fluid distribution manifold 26. The top of each battery cell 14 includes a top perimeter weld ring 40 that surrounds a center positive pole 44 and a negative pole 46.

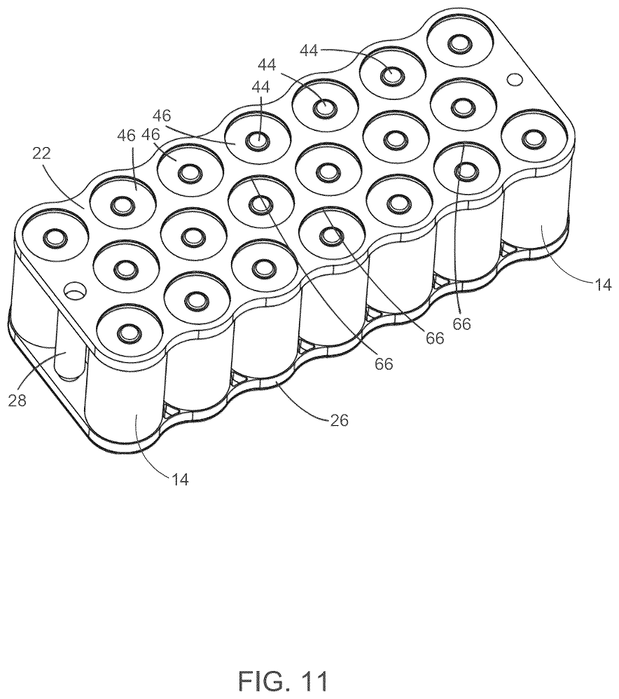

Referring to FIG. 11, the top battery plate 22 is shown connected to each of the battery cells 44. For example, in one embodiment, the top perimeter weld rings 40 on each battery cell 14 can be welded to the top battery plate 22. The connection can provide a fluid-tight seal.

As shown, the top battery plate 22 defines a plurality of battery cell openings 66. In this manner, once the top battery plate 22 is attached to the plurality of battery cells 14, the top of each battery cell remains exposed. In particular, the top battery plate 22 is connected to the battery cells 14 in a way that still allows for electrical connections to be made to the positive poles 44 and the negative poles 46 on each of the battery cells 14.

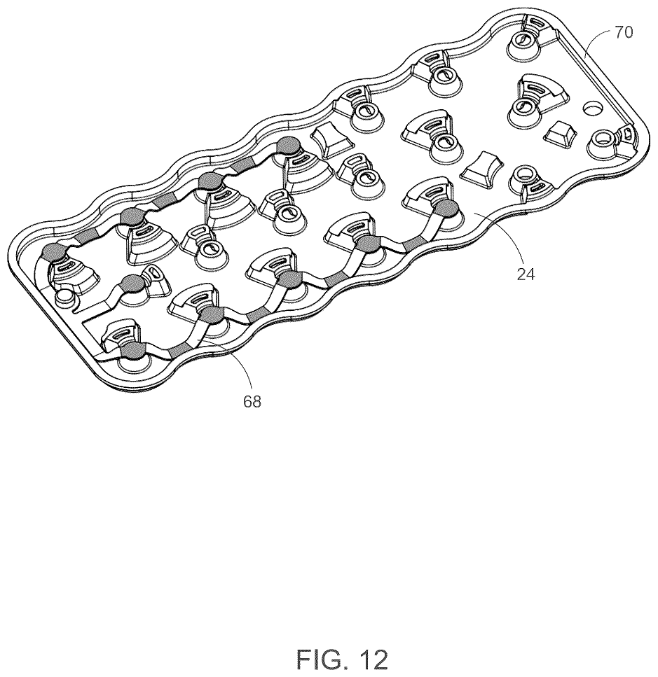

Referring to FIG. 12, the underside of the top cover plate 24 is shown. The top cover plate 24 is designed to attach to the top battery plate 22 using, for instance, a perimeter weld 70. The top cover plate 24 attaches to the top battery plate 22 in a manner that provides a space therebetween for circulating a coolant fluid.

As shown in FIG. 12, in one embodiment, the top cover plate 24 can be preassembled or connected to conductive members that are positioned so as to contact the positive and negative poles on the battery cells 14. In FIG. 12, for instance, a first conductive member 68 is shown. The first conductive member 68 is for connecting to the positive poles 44 on each of the battery cells 14. The first conductive member 68 can be welded or otherwise attached to the underside of the top plate 24.

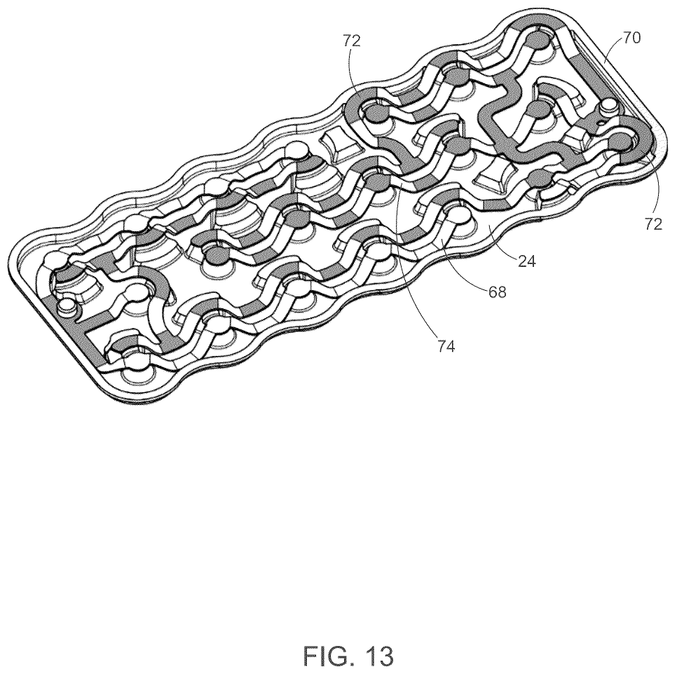

Referring to FIG. 13, the underside of the top cover plate 24 is shown including not only the first conductive member 68 but also a second conductive member 72. The second conductive member 72 is for connecting to the negative poles 46 on the battery cells 14. Optionally, the battery pack assembly can include a third conductive member 74 which serves as a return bus bar that is connected to negative poles 46 of the battery cells 14 and attached to the positive bus bar or first conductive member 68. The third conductive member 74 or return bus bar can also be welded or otherwise attached to the positive poles 44 of the battery cells 14 attached to the second conductive member or negative bus bar 72.

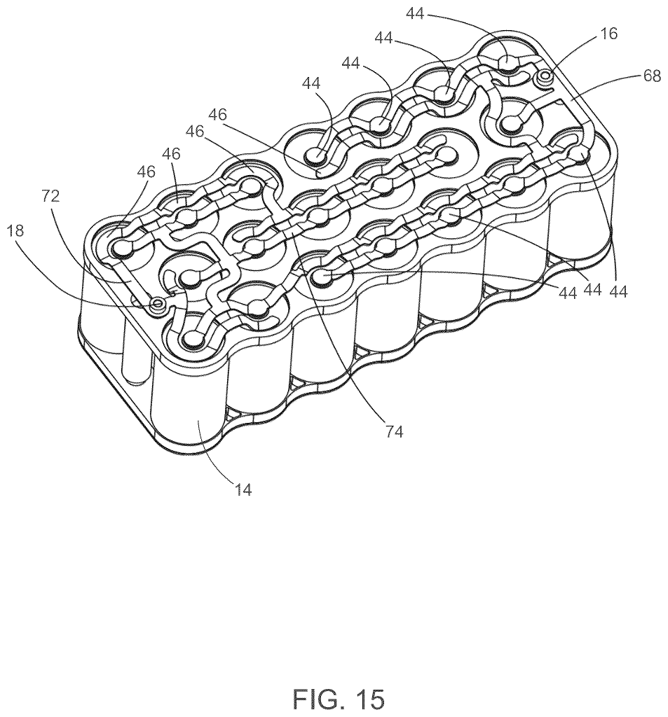

Referring to FIG. 15, the conductive members 68, 72 and 74 are shown connected to the battery cells 14 with the top cover plate removed. The conductive members 68, 72 and 74, in one embodiment, can be welded to the positive poles 44 and to the negative poles 46 of the battery cells 14. In one aspect, the connections can be made through laser welding. Alternatively, the connections can be made through ultrasonic welding.

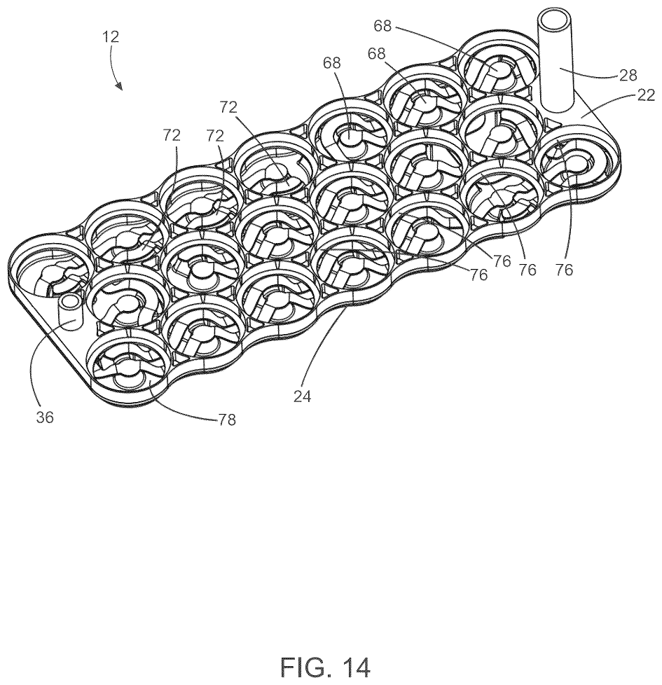

Referring to FIG. 14, the top cooling fluid distribution manifold 12 is shown in an assembled condition. The top cooling fluid distribution manifold 12 includes a top battery plate 22 that has been attached to a top cover plate 24. Attached to the top cover plate 24 are conductive members including the first conductive members 68 and the second conductive member 72 for making electrical connections to a plurality or bank of battery cells 14. As shown in FIG. 14, the top battery plate 22 can include a plurality of circumferential welding bands 76 that can be welded to the top perimeter weld rings 40 on each of the battery cells 14. The top battery plate 22 can form a liquid-tight seal against each of the battery cells 14.

As shown particularly in FIG. 14, once the top battery plate 22 is attached to the top cover plate 24, a space 78 is formed between the top battery plate 22 and the top cover plate 24 for circulating a coolant fluid. Of particular advantage, the coolant fluid can directly contact the top of each battery cell 14 and can directly contact each of the conductive members 68, 72 and 74. In this manner, the coolant fluid can provide maximum cooling in a simple and efficient way. Coolant fluid can enter the space 78 through the fluid inlets 36 and can then circulate through the top cooling fluid distribution manifold 12 and exit through the cooling fluid channel 28 for circulation through the bottom cooling fluid distribution manifold 26.

In the figures, the battery pack assembly is shown attached to three banks of battery cells 14. In the figures, 20 battery cells are integrated into the battery pack assembly. It should be understood, however, that the battery pack assembly can be modified to accommodate less or more battery cells. For instance, the battery pack assembly can be configured to hold from about four to about 100 individual battery cells, including all increments of one battery cell therebetween. For instance, the battery pack assembly can be configured to hold greater than about 10 battery cells, such as greater than about 15 battery cells, such as greater than about 20 battery cells, such as greater than about 25 battery cells, such as greater than about 30 battery cells, such as greater than about 35 battery cells, such as greater than about 40 battery cells, such as greater than about 45 battery cells, such as greater than about 50 battery cells, and less than about 100 battery cells, such as less than about 90 battery cells, such as less than about 80 battery cells, such as less than about 70 battery cells, such as less than about 60 battery cells.

Once the battery pack of the present disclosure is assembled as shown in FIGS. 1 and 2, a consolidated assembly is created that not only provides protection to the battery cells but also provides electrical connections and an efficient method of circulating a coolant fluid that directly contacts each of the battery cells.

Of particular advantage, the top battery plate 22, the top cover plate 24, the bottom battery plate 30 and the bottom cover plate 32 can all be made from a polymer composition. In this manner, the battery pack assembly is lightweight while still providing significant impact resistance. In one aspect, the different components or parts can be injection molded from a thermoplastic polymer. The thermoplastic polymers that can be used include aliphatic polyamides, such as polyamide 66, polyamide 6, polyamide 11, polyamide 11, polyamide 12, polyamide 610, polyamide 66/610, polyamide 6/12, polyamide 666; semi-aromatic polyamides, such as polyamides having all or a portion of their diacid units deriving from terephthalate and/or iso-phthalate, such as PA6T, polyamide 6IT, PA6T/66, PA6T/DT and PA6T/61; polyolefins, such as polypropylene; polyesters, such as poly(butylene terephthalate), poly(ethylene terephthalate); copolyether esters, such as those having hard segments comprised of PBT, PET and/or PTT and soft segments comprised of poly(C2-4-alkylene oxide)diols; polyphenylene sulfide (PPS); polyacetal; or liquid-crystal polymers.

In one aspect, the polymer composition can also include a reinforcing filler, such as glass fibers. The reinforcing filler, for instance, can be present in the polymer composition in an amount greater than about 5% by weight, such as in an amount greater than about 10% by weight, such as in an amount greater than about 15% by weight, such as in an amount greater than about 20% by weight, and in an amount less than about 45% by weight, such as in an amount less than about 40% by weight, such as in an amount less than about 35% by weight, such as in an amount less than about 30% by weight.

The battery pack assembly of the present disclosure is particularly well suited for being incorporated into electric vehicles. In one aspect, for instance, the present disclosure is directed to an electric vehicle or to an electric vehicle propulsion system that incorporates the multi-purpose battery pack assembly of the present disclosure.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A battery pack structural and electrical assembly for circulating a coolant fluid comprising:
a top cooling fluid distribution manifold comprising a top battery plate spaced from a top cover plate and defining a space therebetween for circulating a coolant fluid, the top cooling fluid distribution manifold further comprising a first conductive battery member and a second conductive battery member, the first and second conductive battery members being attached to the top cover plate, and wherein the top cooling fluid distribution manifold is configured to attach and seal against a plurality of battery cells for circulating a coolant fluid that contacts the battery cells and the first and second conductive battery members, and wherein the first conductive battery member is positioned so as to contact a positive terminal on a battery cell attached to the top cooling fluid distribution manifold, and wherein the second conductive battery member is positioned so as to contact a negative terminal on a battery cell attached to the top cooling fluid distribution manifold;
a bottom cooling fluid distribution manifold comprising a bottom battery plate spaced from a bottom cover plate and defining a space therebetween for receiving a coolant fluid, the bottom cooling fluid distribution manifold being configured to attach and seal against an opposite side of the plurality of battery cells for circulating a coolant fluid that contacts the battery cells; and
at least one fluid passageway that provides fluid communication between the top cooling fluid distribution manifold and the bottom cooling fluid distribution manifold.

2. A battery pack assembly as defined in claim 1, further comprising a coolant fluid inlet and a coolant fluid outlet that are in fluid communication with the top cooling fluid distribution manifold and the bottom cooling fluid distribution manifold for flowing a coolant fluid through same.

3. A battery pack assembly as defined in claim 2, wherein one of the coolant fluid inlet or coolant fluid outlet is connected to the top cooling fluid distribution manifold and wherein the other coolant fluid inlet or coolant fluid outlet is connected to the bottom cooling fluid distribution manifold and wherein the coolant fluid inlet is positioned adjacent to the coolant fluid outlet.

4. A battery pack assembly as defined in claim 1, wherein the bottom cooling fluid distribution manifold defines a plurality of battery cell vents comprising openings in the bottom cover plate, each opening being positioned to correspond to a battery cell attached to the bottom cooling fluid distribution manifold.

5. A battery pack assembly as defined in claim 4, wherein each battery cell vent is surrounded by a vent weld ring that is configured to be welded to a corresponding battery cell for preventing a coolant fluid circulating through the bottom cooling fluid distribution manifold from entering the battery cell vents.

6. A battery pack assembly as defined in claim 5, wherein the bottom plate includes a plurality of perimeter weld rings, each perimeter weld ring surrounding and being spaced from a corresponding vent weld ring, each perimeter weld ring being configured to attach to a corresponding battery cell.

7. A battery pack assembly as defined in claim 1, wherein the top cooling fluid distribution manifold defines a plurality of weld access openings, the weld access openings being positioned over the first conductive battery member and over the second conductive battery member, the weld access openings being configured to provide access to the first conductive battery member for welding the first conductive battery member to corresponding positive terminals on battery cells attached to the top cooling fluid distribution manifold and being configured to provide access to the second conductive battery member for welding the second conductive battery member to corresponding negative terminals on battery cells attached to the top cooling fluid distribution manifold.

8. A battery pack assembly as defined in claim 1, wherein the top cooling fluid distribution manifold includes a positive terminal in electrical communication with the first conductive battery member and a negative terminal in communication with the second conductive battery member.

9. A battery pack assembly as defined in claim 1, wherein the top battery plate of the top cooling fluid distribution manifold defines a plurality of battery cell openings for mating with a corresponding plurality of battery cells, each battery cell opening being surrounded by a top perimeter weld ring for welding to a corresponding battery cell.

10. A battery pack assembly as defined in claim 1, wherein the top battery plate and the top cover plate of the top cooling fluid distribution manifold and the bottom cooling fluid distribution manifold are comprised of a polymer.

11. A battery pack assembly as defined in claim 10, wherein the polymer comprises a thermoplastic resin containing reinforcing fibers.

12. A battery pack assembly as defined in claim 10, wherein the polymer comprises a polyamide, a polyolefin, a polyester, a copolyether ester, a polyphenylene sulfide, a polyoxymethylene, or a liquid crystal polymer.

13. A battery pack assembly as defined in claim 10, wherein the top battery plate, the top cover plate, and the bottom cooling fluid distribution manifold are injection molded.

14. A battery pack assembly as defined in claim 1, wherein the first conductive battery member and the second conductive battery member comprise a conductive metal.

15. A battery pack comprising a battery pack structural and electrical assembly as defined in claim 1 and a plurality of battery cells mounted and electrically interconnected between the top cooling fluid distribution manifold and the bottom cooling fluid distribution manifold.

16. A battery pack as defined in claim 15, wherein each of the battery cells has a cylindrical shape.

17. A battery pack as defined in claim 15, wherein each battery cell includes a top positioned adjacent to the top cooling fluid distribution manifold and a bottom positioned adjacent to the bottom cooling fluid distribution manifold and wherein each battery cell is welded at the top to the top cooling fluid distribution manifold and is welded at the bottom to the bottom cooling fluid distribution manifold.

18. A battery pack as defined in claim 17, wherein each battery cell is laser welded to at least one of the distribution manifolds.

19. A battery pack as defined in claim 17, wherein each battery cell is ultrasonically welded to at least one of the distribution manifolds.

20. A battery pack as defined in claim 15, wherein the first conductive battery member and the second conductive battery member comprise conductive metals.

21. A battery pack as defined in claim 15, wherein the battery pack further comprises a coolant fluid that circulates through the top cooling fluid distribution manifold and through the bottom cooling fluid distribution manifold, the coolant fluid comprising a dielectric oil, a fluorinated oil, a mineral oil, or a glycol.

22. A battery pack as defined in claim 15, wherein the battery pack includes at least ten battery cells.
